(19) United States
(12) Patent Application Publication
(10) Pub. No.: US 2004/0172832 A1
(43) Pub. Date: Sep. 9, 2004

(54) Razor blade

(76) Inventors: Colin Clipstone, Weston, MA (US); Steve S. Hahn, Wellesley, MA (US); Yiqian Eric Liu, Lexington, MA (US); Neville Sonnenberg, Newton, MA (US); Andrew Zhuk, Acton, MA (US)

Correspondence Address: FISH & RICHARDSON PC, 225 FRANKLIN ST, BOSTON, MA, 02110, US

(21) Appl. No.: 10/379,264

(22) Filed: Mar. 4, 2003

(51) Int. Cl. B26B 21/00; B26B 9/00

(52) U.S. Cl. 30/50; 30/346

(57) ABSTRACT

A razor blade includes a substrate with a cutting edge and a coating of a carbon-containing material doped, for example, with chromium.

### TECHNICAL FIELD

The invention relates to razors and razor blades.

### BACKGROUND

A razor blade is typically formed of a suitable substrate material such as stainless steel, and a cutting edge is formed with a wedge-shaped configuration with an ultimate tip having a radius less than about 1000 angstroms, e.g., about 200-300 angstroms. Hard coatings such as diamond, amorphous diamond, diamond-like carbon (DLC), nitrides, carbides, oxides or ceramics are often used to improve strength, corrosion resistance and shaving ability, maintaining needed strength while permitting thinner edges with lower cutting forces to be used. Polytetrafluoroethylene (PTFE) outer layer can be used to provide friction reduction. Interlayers of niobium or chromium containing materials can aid in improving the adhesion between the substrate, typically stainless steel, and hard carbon coatings, such as DLC. Examples of razor blade cutting edge structures and processes of manufacture are described in U.S. Pat. Nos. 5,295,305; 5,232,568; 4,933,058; 5,032,243; 5,497,550; 5,940,975; 5,669,144; EP 0591334; PCT 92/03330, and PCT 01/64406, which are hereby incorporated by reference.

It is known that an overlayer of chromium can be used between the hard carbon coating and the PTFE outer layer.

### SUMMARY

Generally, the invention features a razor blade including a cutting edge defined by a sharpened tip and adjacent facets. The cutting edge includes a coating of a carbon-containing material (for example, DLC) including a dopant. The dopant may be silicon or a metal such as chromium, titanium, molybdenum, niobium, or tungsten. The carbon-containing material preferably includes from 1 to 10 atomic percent, and more preferably from 1 to 5 atomic percent, of the dopant.

In one embodiment, the dopant is chromium and the razor blade further includes a coating of PTFE on the coating of carbon-containing material without any intervening layer (for example, a chromium overlayer).

In another embodiment, the dopant again is chromium and the razor blade does not include an interlayer between the cutting edge and the coating of carbon-containing material. The razor blade also may include a coating of PTFE and, optionally, an overlayer between the coating of carbon-containing material and the coating of PTFE.

The invention also features razors including razor blades having the coating of carbon-containing material including a dopant. In some embodiments, the dopant provides the razor blade with improved thermal stability and wear resistance.

The invention also features making razor blades including a carbon-containing material including a dopant. In one embodiment, a razor blade is made by adding a coating of a carbon-containing material including a dopant (preferably chromium) to the cutting edge. A coating of PTFE then is added directly to the coating of carbon-containing material by contacting the coating of carbon-containing material with an aqueous dispersion of PTFE.

Other features and advantages of the invention will be apparent from the following description of embodiments and from the claims.

### DESCRIPTION OF DRAWINGS

FIG. 1 is a vertical sectional view of a cutting edge portion of an embodiment of a razor blade;

FIG. 2 is a perspective view of a razor including the FIG. 1 razor blade; and

FIG. 3 is a vertical sectional view of a cutting edge portion of an alternate embodiment of a razor blade.

### DETAILED DESCRIPTION

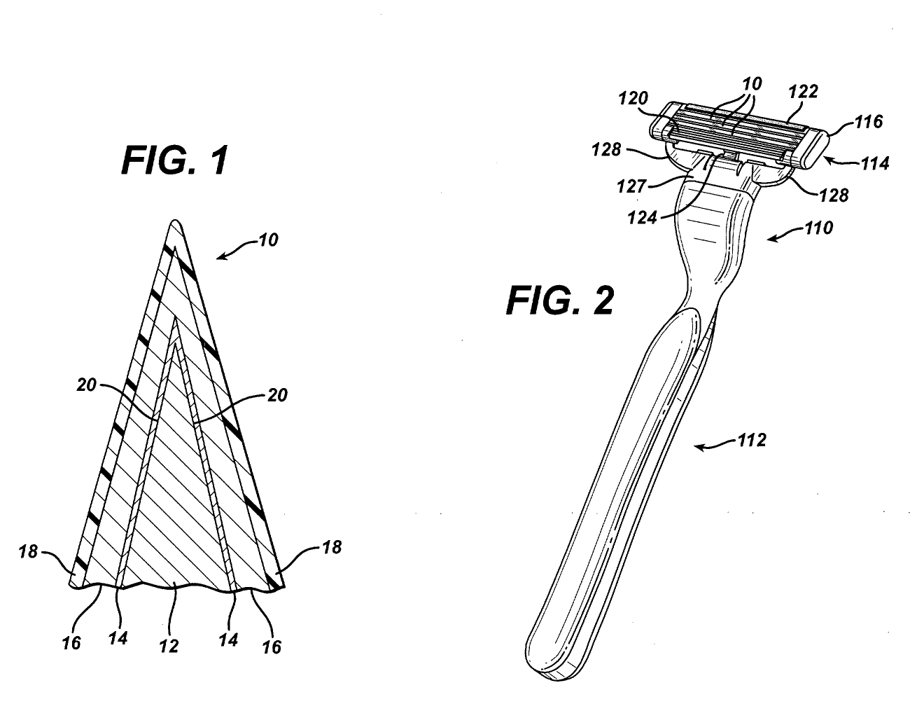

Referring to FIG. 1, razor blade 10 includes substrate 12, interlayer 14, hard carbon layer 16, and outer layer 18. Substrate 12 typically is made of stainless steel (though other substrates can be employed) and has an ultimate edge sharpened to a tip radius of less than 1,000 angstroms, preferably 200 to 300 angstroms, and has a profile with side facets 20 at an included angle of between 15 and 30 degrees, preferably about 19 degrees, measured at 40 microns from the tip.

Interlayer 14 is used to facilitate bonding of the hard coating layer to the substrate. Examples of suitable interlayer material are niobium and chromium-containing materials. A particular interlayer is made of niobium greater than 100 angstroms and preferably less than 500 angstroms thick. PCT 92/03330 describes use of a niobium interlayer.

Hard carbon layer 16 provides improved strength, corrosion resistance and shaving ability and can be made from carbon-containing materials such as diamond, amphorous diamond, and DLC that have been doped with chromium. The carbon-containing material is doped with chromium by including chromium in the target during application of the carbon layer during sputtering. The chromium may be chromium metal or, for example, an alloy of chromium such as CrPt. The carbon-containing material preferably includes from 0.1 to 10 atomic percent chromium, and more preferably from 0.5 to 7 atomic percent or 1 to 5 atomic percent chromium. The carbon-containing material can also incorporate hydrogen, for example, hydrogenated DLC.

A particular embodiment of a hard carbon layer is DLC doped with 2 atomic percent chromium. The layer preferably is less than 2,000 angstroms thick, and more preferably less than 1,000 angstroms think. DLC coatings and methods of depositions are described in U.S. Pat. No. 5,232,568, which is hereby incorporated by reference. The general procedure described in U.S. Pat. No. 5,232,568 is modified in that a graphite target doped with 2 atomic percent chromium was used in place of a pure graphite target. The chromium-doped DLC layer can be applied, for example, by using sputtering using a DC bias of about −500 volts and a pressure of about 2 mtorr. As described in the “Handbook of Physical Vapor Deposition (PVD) Processing,” DLC is an amphorous carbon material that exhibits many of the desirable properties but does not have the crystalline structure of diamond.

Outer layer 18 provides reduced friction and includes PTFE and is sometimes referred to as a telomer. A preferred PTFE material is Krytox LW 1200, available from DuPont. This material is a nonflammable and stable dry lubricant that consists of small particles that yield stable dispersions. It is furnished as an aqueous dispersion of about 20% solids by weight and can be applied by dipping, spraying, or brushing, and can thereafter be air-dried or melt coated. The layer is preferably less than 5,000 angstroms and could typically be 1,500 angstroms to 4,000 angstroms, and can be as thin as 100 angstroms, provided that a continuous coating is maintained. Provided that a continuous coating is achieved, reduced telomer coating thickness can provide improved first shave results. U.S. Pat. Nos. 5,263,256 and 5,985,459, which are hereby incorporated by reference, describe techniques which can be used to reduce the thickness of an applied telomer layer.

The polytetrafluoroethylene layer adheres well to the chromium-doped DLC layer even though the polytetrafluoroethylene was applied directly to the chromium-doped DLC layer as an aqueous dispersion. It is believed that the chromium dopant aids in the adhesion between the layers.

Razor blade 10 is made generally according to the processes described in the above referenced patents. A particular embodiment includes a 200 angstroms thick niobium interlayer 14, a 700 angstroms thick chromium-doped DLC layer 16, and a 200 angstroms thick Krytox LW1200 polytetrafluoroethylene outer coat layer 18. Blade 10 preferably has a tip radius of about 200-400 angstroms, measured by SEM before adding outer layer 18.

Referring to FIG. 2, blade 10 can be used in shaving razor 110, which includes handle 112 and replaceable shaving cartridge 114. Cartridge 114 includes housing 116, which carries three blades 10, guard 120 and cap 122. Blades 10 are movably mounted, as described, e.g., in U.S. Pat. No. 5,918,369, which is incorporated by reference. Cartridge 114 also includes interconnect member 124 on which housing 116 is pivotally mounted at two arms 128. Interconnect member 124 includes a base 127 which is replaceably connected to handle 112. Alternatively, blade 10 can be used in other razors having one, two, three, or more than three blades, double-sided blades, and razors that do not have movable blades or pivoting heads where the cartridge is either replaceable or permanently attached to a razor handle.

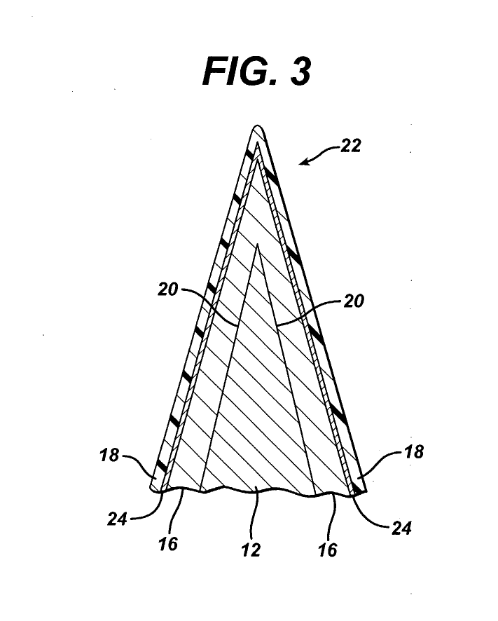

Referring to FIG. 3, an alternative razor blade 22 includes substrate 12, hard carbon layer, 16, overcoat layer 24, and outer layer 18. The substrate, hard carbon layer, and outer layer generally are the same as in razor blade 10.

Overcoat layer 24 is discussed in U.S. Ser. No. 09/515,421, which is hereby incorporated by reference. The overcoat layer reduces the tip rounding of the hard coated edge and can facilitate bonding of the outer layer to the hard coating while still maintaining the benefits of both. Overcoat layer 24 is preferably made of chromium containing material, e.g., chromium or chromium alloys, e.g. CrPt, that are compatible with polytetrafluoroethylene. A particular overcoat layer is chromium about 100-200 angstroms thick. Blade 10 has a cutting edge that has less rounding with repeated shaves than it would have without the overcoat layer. Chromium overcoat layer 24 is deposited to a minimum of 100 angstroms and a maximum of 500 angstroms. It is deposited by sputtering using a DC bias (more negative than −50 volts and preferably more negative than −200 volts) and pressure of about 2 millitorr argon. The increased negative bias is believed to promote a compressive stress (as opposed to a tensile stress), in the chromium overcoat layer which is believed to promote improved resistance to tip rounding while maintaining good shaving performance. Blade 10 preferably has a tip radius of about 200-400 angstroms, measured by SEM after application of overcoat layer 24 and before adding outer layer 20.

Hard carbon layer 16, which is doped with chromium, adheres to substrate 12 even though the hard carbon layer is deposited directly on the substrate, without an interlayer. It is believed that the presence of the chromium dopant aids in the adhesion between the hard carbon layer and the cutting edge.

Other embodiments are within the claims. For example, the razor blade optionally may include neither an interlayer 14 nor an overcoat layer 24. In addition, titanium, niobium, tungsten, molybdenum, or silicon may be used in place of, or in addition to chromium, as the dopant in the hard carbon material.

Moreover, the razor blade may include two or more hard carbon layers. Each layer can include a different quantity of dopant and one or more layers may include no dopant. The hard carbon layers may include the same or different carbon-containing material.

For example, a hard carbon-containing layer may include a variable quantity of dopant. For example, the inner surface of the hard carbon layer may include 1 atomic percent dopant, and that quantity may increase among a gradient, with the outer surface of the hard carbon layer including 5 or 10 atomic percent of the dopant.

In addition, a hard carbon-containing layer may include two or more dopants selected, for example, from those mentioned previously.

Other embodiments are within the claims.

What is claimed is:

1. A razor blade, comprising
a substrate with a cutting edge defined by a sharpened tip and adjacent facets;
a coating of a carbon-containing material, doped with chromium, on the cutting edge; and
a coating of polytetrafluoroethylene on the coating of a carbon-containing material;
wherein there is no overcoat layer between the coating of a carbon-containing material and the coating of polytetrafluoroethylene.

2. A razor blade, comprising
a substrate with a cutting edge defined by a sharpened tip and adjacent facets;
a coating of a carbon-containing material, doped with chromium, on the cutting edge; and
a coating of polytetrafluoroethylene on the coating of a carbon-containing material;
wherein there is no interlayer between the coating of a carbon-containing material and the cutting edge.

3. The razor blade of claims 1 or 2, wherein the coating of a carbon-containing material includes from 0.1 to 10 atomic percent chromium.

4. The razor blade of claims 1 or 2, wherein the coating of a carbon-containing material includes from 1 to 5 atomic percent chromium.

5. The razor blade of claims 1 or 2, wherein the coating of a carbon-containing material is diamond-like carbon.

6. The razor blade of claims 1 or 2, wherein the coating of a carbon-containing material is selected from the group consisting of diamond and amphorous diamond.

7. The razor blade of claim 1, further comprising an interlayer between the coating of a carbon-containing material and the cutting edge.

8. The razor blade of claim 7, wherein the interlayer comprises niobium.

9. The razor blade of claim 2, further comprising an overcoat layer between the coating of a carbon-containing material and the coating of polytetrafluoroethylene.

10. The razor blade of claim 9, wherein the overcoat layer comprises chromium.

11. The razor blade of claims 1 or 2, wherein the coating of a carbon-containing material has
a thickness less than 2,000 angstroms and the coating of polytetrafluoroethylene has a thickness between 100 and 5,000 angstroms.

12. A shaving razor comprising
a handle;
a housing connected to the handle; and
at least one razor blade mounted in the housing, the razor blade comprising a substrate with a cutting edge defined by a sharpened tip and adjacent facets, a coating of a carbon-containing material doped with chromium on the cutting edge, and a coating of polytetrafluoroethylene on the a coating of a carbon-containing material;
wherein there is no overcoat layer between the coating of a carbon-containing material and the coating of polytetrafluoroethylene.

13. A shaving razor comprising:
a handle;
a housing connected to the handle; and
at least one razor blade mounted in the housing, the razor blade comprising a substrate with a cutting edge defined by a sharpened tip and adjacent facets, a coating of a carbon-containing material doped with chromium on the cutting edge, and a coating of polytetrafluoroethylene on the coating of a carbon-containing material;
wherein there is no interlayer between the coating of a carbon-containing material and the cutting edge.

14. A method of making a razor blade comprising
coating a substrate having a cutting edge defined by a sharpened tip and adjacent facets with a carbon-containing material doped with chromium; and
coating the coating of carbon-containing material with polytetrafluoroethylene by contacting the coating of a carbon-containing material directly with an aqueous dispersion including polytetrafluoroethylene.

15. A razor blade, comprising
a substrate with a cutting edge defined by a sharpened tip and adjacent facets; and
a coating of diamond-like carbon on the cutting edge, the coating including from 0.1 to 10 atomic percent of a dopant.

16. The razor blade of claim 15, wherein the coating includes from 1 to 5 atomic percent of a dopant.

17. The razor blade of claim 15, wherein the dopant is selected from the group consisting of titanium, niobium, tungsten, molybdenum, and silicon.

18. The razor blade of claim 17, wherein the dopant is selected from the group consisting of niobium, molybdenum, and silicon.

19. The razor blade of claim 17, wherein the dopant is chromium.

20. The razor blade of claim 15, further comprising an interlayer between the coating of diamond-like carbon and the cutting edge.

21. The razor blade of claim 15, further comprising a coating of polytetrafluoroethylene on the coating of diamond-like carbon.
